(19) United States
(12) Patent Application Publication
(10) Pub. No.: US 2013/0329032 A1
(43) Pub. Date: Dec. 12, 2013

(54) FUNDUS CAMERA AND METHOD OF CAPTURING FUNDUS IMAGE

(71) Applicant: CANON KABUSHIKI KAISHA, Tokyo (JP)

(72) Inventor: Kazuhiko Takahashi, Kawasaki-shi (JP)

(21) Appl. No.: 13/905,494

(22) Filed: May 30, 2013

(30) Foreign Application Priority Data
Jun. 7, 2012 (JP) 2012-130197

(51) Int. Cl. H04N 5/232

(52) U.S. Cl. CPC H04N 5/23212
USPC 348/78

(57) ABSTRACT

A fundus camera having an autofocus function which automatically drives a focus lens, the camera includes a general-purpose digital camera having a live view function, an acquisition unit which acquires a live view image captured by the general-purpose digital camera, and a control unit which drives the focus lens based on the live view image.

### BACKGROUND OF THE INVENTION

1. Field of the Invention

The present invention relates to a fundus camera and a method of capturing a fundus image and, more particularly, to an autofocus fundus camera and a method of capturing a fundus image.

2. Description of the Related Art

A fundus camera which images the fundus of an eye to be examined is known. Fundus camera types include mydriatic fundus cameras, non-mydriatic fundus cameras, and full-featured mydriatic/non-mydriatic fundus cameras. A mydriatic fundus camera is an apparatus configured to observe and image an eye to be examined which is treated with a mydriatic agent (mydriatic eye) by using visible light. A non-mydriatic fundus camera is an apparatus configured to observe an eye to be examined which is not treated with any mydriatic agent (non-mydriatic eye) by using near infrared light and image the eye by instantaneously illuminating the eye with visible light (see, for example, Japanese Patent Laid-Open No. 9-308610 (to be referred to as literature 1 hereinafter)). A full-featured mydriatic/non-mydriatic fundus camera is an apparatus obtained by integrating a mydriatic fundus camera with a non-mydriatic fundus camera. The full-featured mydriatic/non-mydriatic fundus camera implements multiple functions (see, for example, Japanese Patent Laid-Open No. 9-66030 (to be referred to as literature 2 hereinafter)).

In addition, a fundus camera equipped with an autofocus function has been proposed. For example, Japanese Patent Laid-Open No. 2011-15844 (to be referred to as literature 3 hereinafter) discloses a fundus camera equipped with an autofocus function based on a contrast focusing scheme. The contrast autofocus function is a function configured to control the focus lens to maximize the contrast of a fundus image. In addition, Japanese Patent Laid-Open No. 2009-172157 (to be referred to as literature 4 hereinafter) discloses a fundus camera equipped with an autofocus function based on a split focusing scheme. The split focusing scheme is a focusing scheme using a phenomenon in which the lens is in focus when two indices split from one bar (to be referred to as focus split indices hereinafter) are projected on the fundus, and the focus split indices are aligned in a straight line.

Recently, a general-purpose digital camera of a single-lens reflex type has often been used as a camera for fundus imaging. The general-purpose digital camera has a live view function to determine a composition at the time of imaging or check at the time of recording a moving image. This live view function is used to observe the fundus and focus the camera. For example, Japanese Patent Laid-Open No. 2011-45552 (to be referred to as literature 5 hereinafter) discloses a fundus camera using a live view function.

Although a fundus camera using a general-purpose digital camera is available as disclosed in literature 5, there is no fundus camera on the market which is equipped with an autofocus function using output images from a general-purpose digital camera. Furthermore, the fundus camera disclosed in literature 3 implements an autofocus function by using a general-purpose digital camera, but does not use any images (for example, live view images and moving images) output from the general-purpose camera for autofocus control.

The fundus camera disclosed in literature 3 uses the focusing evaluation value generated by the general-purpose digital camera as a focusing evaluation value necessary for autofocus control. It is not generally possible to change the design specifications of a general-purpose digital camera. This makes it impossible for the designer of a fundus camera to customize a calculation algorithm for focusing evaluation values even if he/she wants to optimize it for fundus images. As described above, the fundus camera disclosed in literature 3 has a problem that it is difficult to optimize the camera for fundus images.

Some conventional fundus cameras equipped with an autofocus function are equipped with two cameras, namely a general-purpose digital camera and an industrial digital camera. Such a fundus camera uses the general-purpose digital camera for still image capturing and uses the industrial digital camera for autofocus control and the like. A fundus camera having such an arrangement includes two cameras, and hence has a problem of high cost.

As another example of a camera having a conventional arrangement, there is available a fundus camera which implements an autofocus function by using only an industrial digital camera. The technical advancement of industrial digital cameras is slower than that of general-purpose digital cameras which have accommodated technical innovations concerning increases in resolution and image quality every year. For this reason, it is difficult to provide the user with high-resolution, high-quality fundus images.

### SUMMARY OF THE INVENTION

According to an embodiment of the present invention, there are provided an inexpensive fundus camera capable of capturing high-resolution, high-quality fundus images by an autofocus scheme and a fundus imaging method.

Also, according to one embodiment of the present invention, there is provided a fundus camera having an autofocus function which automatically drives a focus lens, the camera comprising: a general-purpose digital camera having a live view function; an acquisition unit configured to acquire a live view image captured by the general-purpose digital camera; and a control unit configured to drive the focus lens based on the live view image.

Further features of the present invention will become apparent from the following description of exemplary embodiments with reference to the attached drawings.

### BRIEF DESCRIPTION OF THE DRAWINGS

FIG. 1 is a view schematically showing the arrangement of the optical system of a fundus camera according to the first embodiment;

FIG. 2 is a block diagram showing the functional blocks of the fundus camera according to the first embodiment;

FIG. 3 is a flowchart showing autofocus processing (autofocus operation) by the fundus camera according to the first embodiment;

FIG. 4 is a view schematically showing the live view image captured by a digital camera 41 in focusing processing by a split focusing scheme;

FIG. 5 is a flowchart showing focusing processing by the split focusing scheme;

FIG. 6 is a graph schematically showing the relationship between focusing evaluation values and focus lens positions in focusing by a contrast focusing scheme;

FIG. 7A is a view schematically showing an arrangement for superimposing the position information of the focus lens on light with which an eye E to be examined is irradiated;

FIG. 7B is a view schematically showing an arrangement for superimposing the time information of a fundus camera on light with which the eye E is irradiated;

FIG. 8 is a flowchart showing a procedure for focusing processing by the contrast focusing scheme of the fundus camera according to the first embodiment;

FIG. 9 is a view schematically showing an example of the live view image output from a digital camera;

FIG. 10 is a graph (upper portion) showing the relationship between the time and the amount of light emitted by an object illumination unit and a graph (lower portion) showing the relationship between the time and the position of the focus lens;

FIG. 11 is a graph (upper portion) showing the relationship between the time and the amount of light emitted by an object illumination unit and a graph (lower portion) showing the relationship between the time and the position of the focus lens in a first modification of the first embodiment;

FIG. 12 is a graph (upper portion) showing the relationship between the time and the amount of light emitted by the object illumination unit and a graph (lower portion) showing the relationship between the time and the position of the focus lens in a second modification of the first embodiment;

FIG. 13 is a block diagram schematically showing the arrangement of a fundus camera according to the second embodiment;

FIGS. 14A and 14B are views each schematically showing an example of the display mode of the current position of a focus lens by a lens position display unit;

FIG. 15 is a flowchart showing the content of focusing processing by the contrast focusing scheme of the fundus camera according to the second embodiment;

FIG. 16 is a block diagram schematically showing the arrangement of a fundus camera according to the third embodiment of the present invention; and

FIG. 17 is a view schematically showing an example of the image captured by the digital camera of the fundus camera according to the third embodiment.

### DESCRIPTION OF THE EMBODIMENTS

Each embodiment of the present invention will be described in detail below with reference to the accompanying drawings.

### First Embodiment

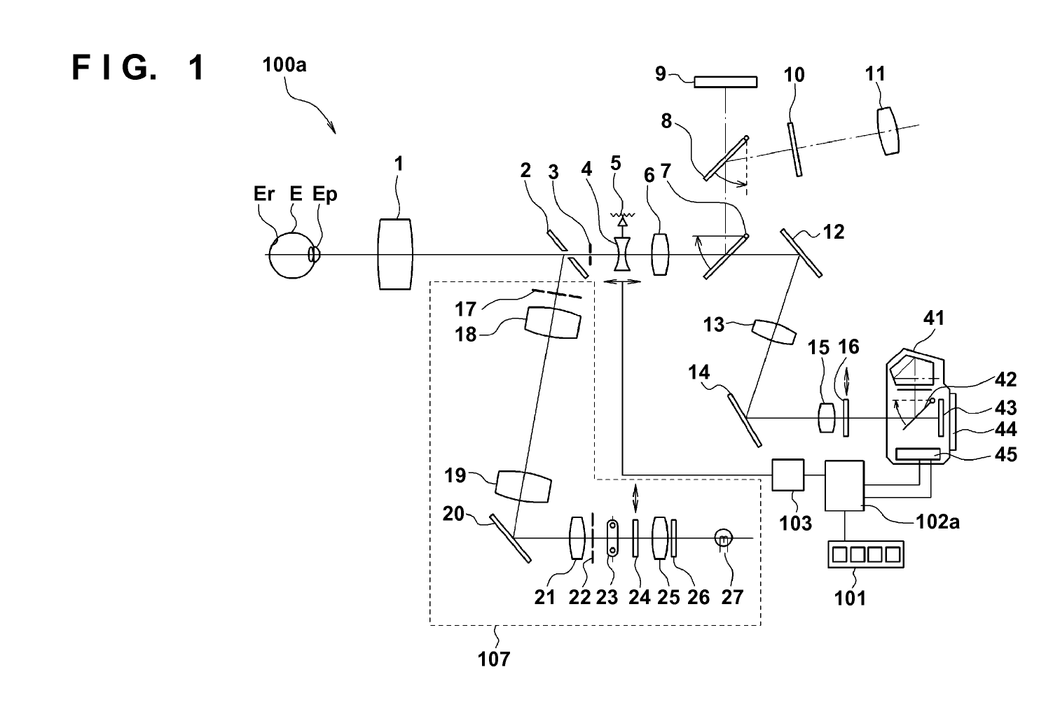

The first embodiment of the present invention is a non-mydriatic fundus camera equipped with an autofocus function which automatically drives a focus lens. First of all, the arrangement of the optical system of a fundus camera 100a according to the first embodiment will be described with reference to FIG. 1. FIG. 1 is a view schematically showing the arrangement of the optical system of the fundus camera 100a according to the first embodiment.

As shown in FIG. 1, the fundus camera 100a according to the first embodiment includes an observation optical system facing an eye E to be examined. The observation optical system includes an objective lens 1, a perforated mirror 2, an imaging stop 3, a focus lens 4, a potentiometer 5, an imaging lens 6, and a dichroic flip-up mirror 7. The perforated mirror 2 is disposed to be conjugate to a pupil Ep of the eye E. The focus lens 4 is provided so as to be movable. A lens driving unit 103 drives the focus lens 4. The potentiometer 5 detects the position of the focus lens 4. The observation optical system further includes fixed mirrors 12 and 14, relay lenses 13 and 15, an infrared cut filter 16, and a digital camera 41. The dichroic flip-up mirror 7 transmits near infrared light and reflects visible light. The dichroic flip-up mirror 7 can move to a position at which the mirror is inserted in the optical path of the observation optical path and a position at which the mirror is retracted from the optical path. The digital camera 41 includes a quick return mirror 42, a CMOS area sensor 43, an LCD monitor 44, and a processing circuit 45. The digital camera 41 is attached to the main body of the fundus camera 100a according to the first embodiment through a detachable mount. Note that a general-purpose digital camera is used as the digital camera 41. The CMOS area sensor 43 of the digital camera 41 does not include any infrared cut filter for removing infrared light and has sensitivity in the visible light band and the infrared band.

A viewfinder optical system and an internal fixation lamp 9 are provided in the optical path of light reflected by the dichroic flip-up mirror 7. The viewfinder optical system includes a movable mirror 8, a field stop 10, and an eyepiece lens 11.

An illumination unit 107 (illumination optical system) for illuminating an object is provided in the incident direction of light on the perforated mirror 2. A light source 27 for fundus observation, a diffusion sheet 26, a condenser lens 25, a visible light cut filter 24, and a xenon tube 23 are provided in the optical path of the illumination unit 107. As the light source 27, for example, a halogen lamp or an LED which emits near infrared light is used. The xenon tube 23 is provided to be almost conjugate to the pupil Ep of the eye E. A ring slit 22, a condenser lens 21, a fixed mirror 20, relay lenses 18 and 19, and a cornea baffle 17 are provided in the optical path of the illumination unit 107.

The digital camera 41 has a live view function and can capture still images. The live view function is a function of displaying, on the LCD monitor 44 (display unit), the image formed on the CMOS area sensor 43 (image sensor) as moving image data before capturing a still image. Note that the image captured by using the live view function will be referred to as a live view image. The digital camera 41 observes a fundus portion Er of the eye E and captures an image (fundus image I). At the time of imaging using the live view function, the processing circuit 45 lowers the resolution of a captured live view image (fundus image I) upon thinning out in accordance with the resolution of the LCD monitor 44. The LCD monitor 44 then displays a live view image with a low resolution. The processing circuit 45 also outputs a live view image outside the digital camera 41.

The fundus camera 100a images the fundus portion Er of the eye E (captures the fundus image I) by capturing a still image by causing the xenon tube 23 to emit light. When imaging the fundus portion Er of the eye E, the CMOS area sensor 43 of the digital camera 41 generates the data of the fundus image I having a resolution corresponding to all the pixels. The processing circuit 45 then executes developing processing of the data of the fundus image I and stores the resultant data in a storage medium (not shown) in a predetermined file format.

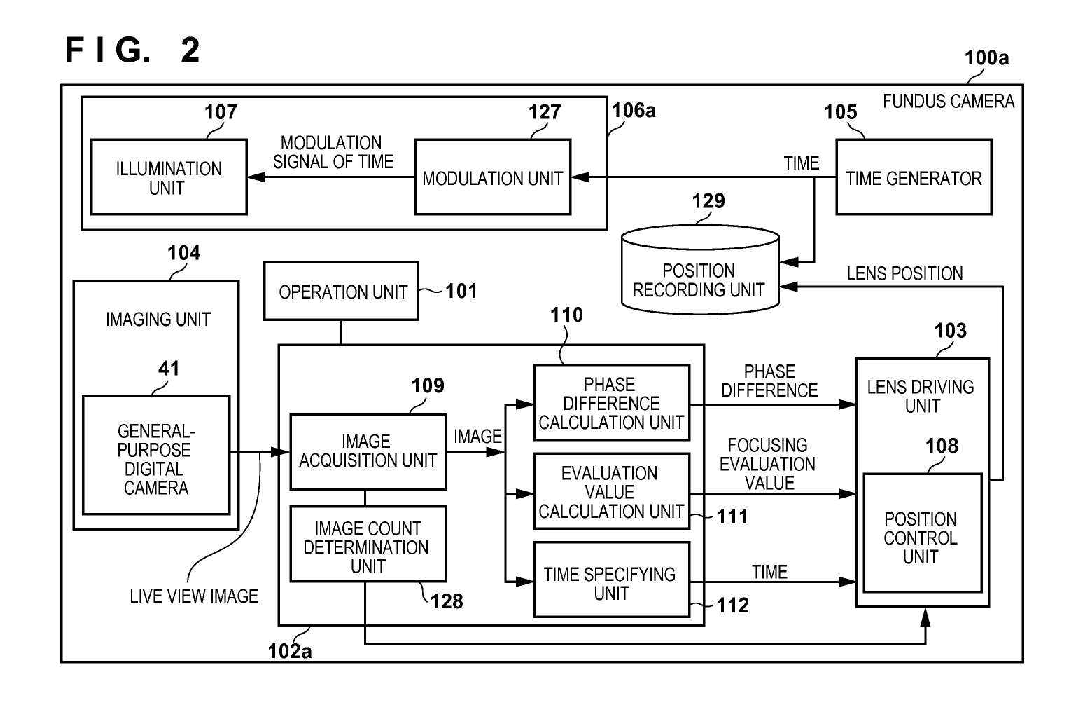

The functional blocks of the fundus camera 100a according to the first embodiment will be described next with reference to FIG. 2. FIG. 2 is a block diagram showing the functional blocks of the fundus camera 100a according to the first embodiment.

As shown in FIG. 2, the fundus camera 100a according to the first embodiment includes an imaging unit 104, an operation unit 101, a control unit 102a, a time generator 105, the lens driving unit 103, a position recording unit 129, and a visualization unit 106a.

The imaging unit 104 observes and images the fundus portion Er of the eye E. The digital camera 41 includes the imaging unit 104.

The operation unit 101 has an arrangement for allowing the examiner (operator) to operate the fundus camera 100a (inputting instructions to it) according to the first embodiment. The operation unit 101 has a user interface for allowing the examiner to operate the fundus camera 100a according to the first embodiment. An input to the operation unit 101 is transmitted to the control unit 102a.

The control unit 102a controls the overall fundus camera 100a according to the first embodiment and each unit based on inputs to the operation unit 101. The control unit 102a includes, as its subsystems, an image acquisition unit 109, an image count determination unit 128, a phase difference calculation unit 110, an evaluation value calculation unit 111, and a time specifying unit 112. The image acquisition unit 109 acquires the fundus image I captured by the digital camera 41 of the imaging unit 104. The image count determination unit 128 determines the number of fundus images I acquired from the digital camera 41 of the image acquisition unit 109. The phase difference calculation unit 110 calculates the phase difference between focus split indices 310 (to be described later) superimposed on the fundus image I acquired by the image acquisition unit 109. The evaluation value calculation unit 111 calculates the focusing evaluation value of the image acquired by the image acquisition unit 109. A focusing evaluation value is a value indicating the degree of focusing. The time specifying unit 112 extracts the time information included in the fundus image I acquired by the image acquisition unit 109 and specifies the imaging time of the fundus image I from the extracted time information (this operation will be described later).

The lens driving unit 103 performs focusing operation by moving the focus lens 4. The lens driving unit 103 has a position control unit 108 as its subsystem. The position control unit 108 controls the position of the focus lens 4.

The time generator 105 generates the time when the fundus camera 100a according to the first embodiment is to be used. The time generated by the time generator 105 is transmitted to the position recording unit 129 and the visualization unit 106a.

The position recording unit 129 records the position of the focus lens 4 together with the time acquired from the time generator 105.

The visualization unit 106a visualizes and superimposes the time information generated by the time generator 105 on a live view image. The visualization unit 106a includes a modulation unit 127 and the illumination unit 107 as its subsystems. The modulation unit 127 generates a modulation signal which is modulated in accordance with the time generated by the time generator 105 (with the lapse of time). As described above, the illumination unit 107 includes the light source 27 and irradiates the eye E with the illumination light generated by the light source 27. The illumination unit 107 can change the amount of illumination light applied to the eye E based on the modulation signal generated by the modulation unit 127.

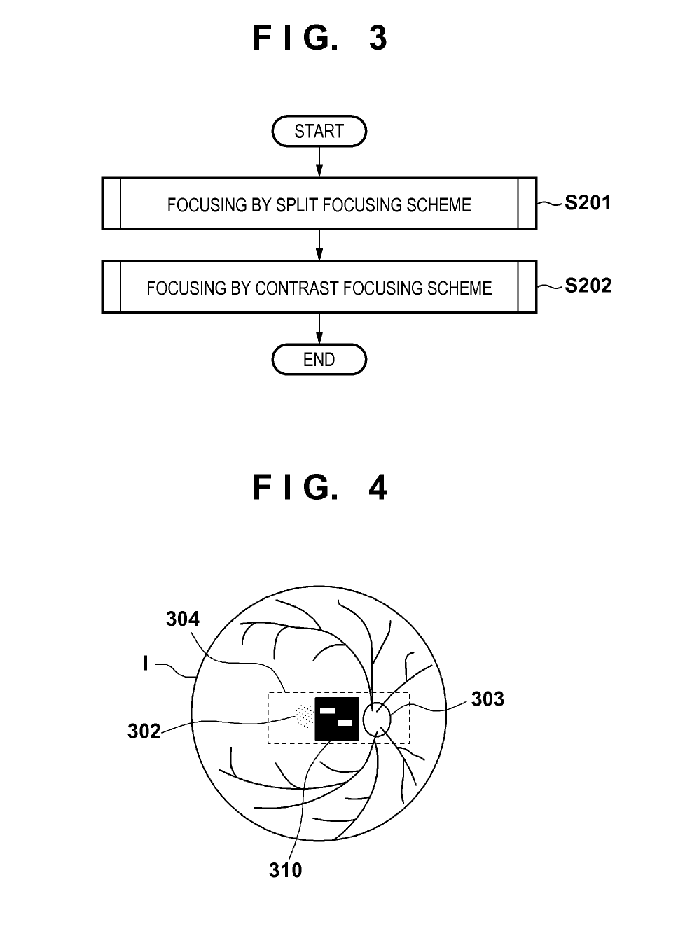

Autofocus processing (autofocus operation) of the fundus camera 100a according to the first embodiment will be described next with reference to FIG. 3 and the like. FIG. 3 is a flowchart showing autofocus processing (autofocus operation) by the fundus camera 100a according to the first embodiment.

The control unit 102a and lens driving unit 103 (autofocus control unit) of the fundus camera 100a according to the first embodiment execute autofocus processing (autofocus operation) upon detection of a “start trigger”. The control unit 102a of the fundus camera 100a according to the first embodiment uses the press of an autofocus start button (not shown) as a “start trigger”. The autofocus start button is a user interface for allowing the examiner (operator) to instruct the fundus camera 100a according to the first embodiment to start autofocus processing (autofocus operation). The autofocus start button is provided on the operation unit 101.

In step S201, the control unit 102a and the lens driving unit 103 execute focusing processing (focusing operation) by the split focusing scheme.

In step S202, the control unit 102a and lens driving unit 103 execute focusing processing (focusing operation) by the contrast focusing scheme after the completion of the focusing processing by the split focusing scheme. The control unit 102a and the lens driving unit 103 terminate the autofocus processing upon completion of the focusing processing by the contrast focusing scheme.

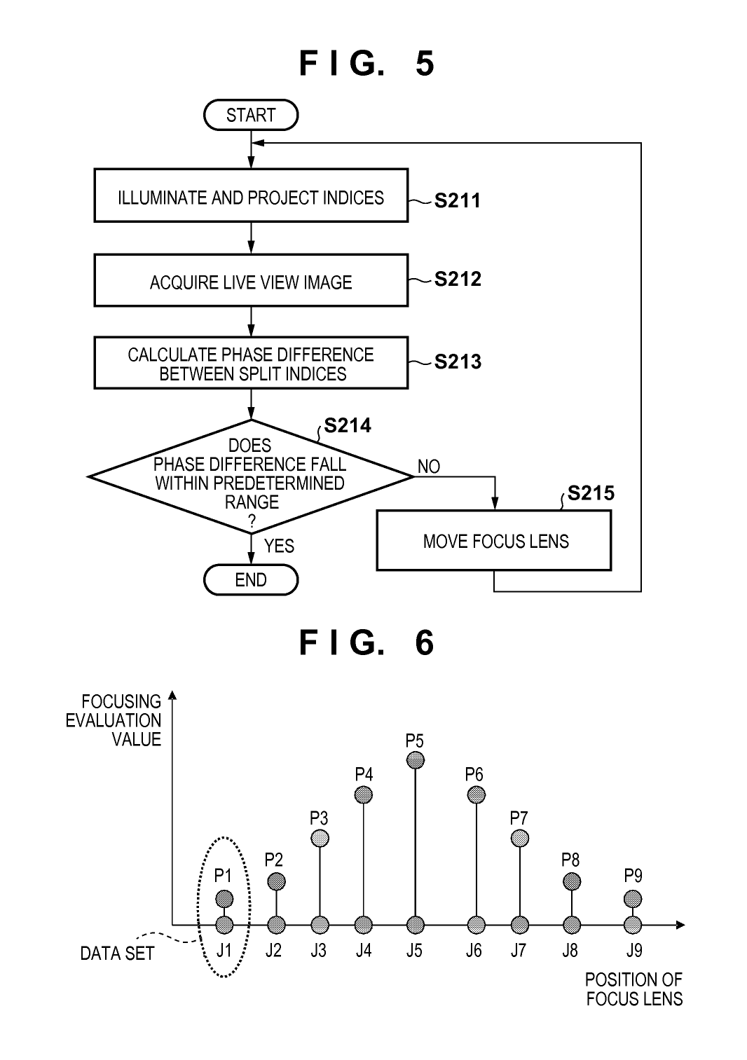

Focusing processing by the split focusing scheme in step S201 will be described below with reference to FIGS. 4 and 5. FIG. 4 is a view schematically showing an example of the live view image (fundus image I) captured by the digital camera 41 in focusing processing by the split focusing scheme. FIG. 5 is a flowchart showing focusing processing by the split focusing scheme.

As shown in FIG. 4, a macular region 302 and a papillary portion 303 are superimposed on a live view image (fundus image I). An area 304 for the calculation of a focusing evaluation value is set in a live view image (fundus image I). A focus split index projection unit (not shown) projects the two focus split indices 310 on the fundus portion Er of the eye E. As a consequence, the two focus split indices 310 are superimposed on the captured live view image (fundus image I). The control unit 102a controls the lens driving unit 103 to move the focus lens 4 so as to eliminate the phase difference (shift amount) between the two focus split indices 310 projected on the fundus portion Er of the eye E. If the phase difference between the two focus split indices 310 falls within a predetermined range (preferably 0), the focus lens is in focus. In the first embodiment, the two focus split indices 310 are configured such that one bar in an almost horizontal direction is split into two portions almost in the middle. The two focus split indices 310 are shifted from each other in the vertical direction. This shift amount corresponds to the phase difference between the focus split indices 310. When the phase difference between the two focus split indices 310 falls within a predetermined range (preferably when the phase difference becomes zero and the two focus split indices 310 look like one bar), the focus lens is in focus. The following is a practical procedure for focusing processing by the split focusing scheme (see FIG. 5).

In step S211, the illumination unit 107 illuminates the fundus portion Er of the eye E with near infrared light. More specifically, the illumination unit 107 has the visible light cut filter 24 inserted on the optical path of the illumination optical system to remove light in the visible light band from the light emitted by the light source 27 (light including visible light and near infrared light). The illumination unit 107 then irradiates the fundus portion Er of the eye E with the near infrared light from which the visible light band is removed. A focus split index projection unit (not shown) projects the two focus split indices 310 on the fundus portion Er of the eye E.

In step S212, the digital camera 41 of the imaging unit 104 images the fundus portion Er of the eye E by using the live view function and outputs the captured live view image (fundus image I) to the image acquisition unit 109. The image acquisition unit 109 acquires one of the live view images output from the digital camera 41. The image acquisition unit 109 then outputs the one acquired live view image to the phase difference calculation unit 110.

In step S213, the phase difference calculation unit 110 calculates the phase difference between the focus split indices 310 from the one output live view image. The phase difference calculation unit 110 outputs the calculated phase difference between the focus split indices 310 to the lens driving unit 103.

In step S214, the lens driving unit 103 determines whether the calculated phase difference falls within a predetermined range. If the lens driving unit 103 determines that the phase difference does not fall within the predetermined range (No in step S214), the process advances to step S215.

In step S215, the position control unit 108 as a subsystem of the lens driving unit 103 drives (moves) the focus lens 4 so as to eliminates the phase difference between the two focus split indices 310. The process then advances to step S211. The camera repeats the processing (operation) in steps S211 to S215 until determining in step S214 that the phase difference falls within the predetermined range.

If the camera determines in step S214 that the phase difference falls within the predetermined range (YES in step S124), the camera terminates the focusing processing by the split focusing scheme (step S201 in FIG. 3).

The content of processing by the above split focusing scheme is an example, and the present invention is not limited to this arrangement. Focusing processing by the split focusing scheme is generally the processing of calculating the phase difference (shift amount) between focus split indices by image recognition and moving the focus lens so as to eliminate the phase difference.

Upon completing focusing processing by the split focusing scheme in step S201, the process shifts to focusing processing by the contrast focusing scheme in step S202 (see FIG. 3). The following is a reason why the camera executes focusing processing by the contrast focusing scheme after performing focusing processing by the split focusing scheme. Focusing processing by the split focusing scheme makes focusing easy if the aberration of the cornea or crystalline lens of the eye E is small, but makes focusing difficult if the aberration is large. It is therefore necessary to find a position at which the focus lens 4 is just in focus by moving it back and forth with reference to the infocus position obtained by the split focusing scheme. This embodiment uses the contrast focusing scheme for this processing.

The description below concerns a problem arising when a fundus camera using a general-purpose digital camera executes focusing processing (focusing operation) by the contrast focusing scheme.

A general-purpose digital camera has high resolution and high image quality and costs high. The general-purpose digital camera generally has no terminal for inputting control signals unlike an industrial digital camera. It is therefore difficult to externally control the general-purpose digital camera. In an arrangement in which the general-purpose digital camera is applied to the imaging unit of a fundus camera, it is difficult to synchronize the internal time of the general-purpose digital camera with that of the fundus camera. In addition, although the general-purpose digital camera can acquire live view images, the cycle of acquiring live view images from the general-purpose digital camera is not sometimes constant. For example, while the general-purpose digital camera can acquire about 10 frames of live view images per sec, it is difficult for the fundus camera to accurately acquire 10 frames of live view images per sec from the general-purpose digital camera. When, for example, the fundus camera acquires live view images from the general-purpose digital camera via a USB, the acquisition cycle tends to vary. Note that there are several reasons why it is difficult for the fundus camera to acquire live view images from the general-purpose digital camera accurately in a predetermined cycle.

As described above, in the arrangement in which the general-purpose digital camera is applied to the imaging unit of the fundus camera, it is difficult to synchronize the internal time of the digital camera with the external time. In addition, it is difficult for the fundus camera to acquire live view images from the digital camera accurately in a predetermined cycle.

For this reason, the following problem arises in focusing processing by the constant focusing scheme. FIG. 6 is a graph schematically showing the relationship between focusing evaluation values and the positions of the focus lens in focusing processing by the constant focusing scheme. As shown in FIG. 6, the fundus camera acquires focusing evaluation values P1, P2, . . . , P9, . . . at positions J1, J2, . . . , J9, . . . of the focus leans while moving the focus lens in focusing processing by the contrast focusing scheme. That is, the fundus camera acquires several to 10 several data sets ((P1, J1), (P2, J2), . . . ), each constituted by the position of the focus lens and a focusing evaluation value at this position, while moving the focus lens. The fundus camera then estimates the position of the focus lens at which the focusing evaluation value is highest from the acquired data sets, and moves the focus lens to the estimated position. Note that a focusing evaluation value is calculated from the live view image output from the general-purpose digital camera.

The arrangement in which an industrial digital camera (a digital camera which can be externally controlled) is applied to the imaging unit can record a captured live view image together with the position of the focus lens at the time point when the live view image was captured. This allows the fundus camera to acquire the position of the focus lens and the focusing evaluation value of the captured image as a set of data. In contrast, in an arrangement using a general-purpose digital camera (a digital camera which cannot be externally controlled), it is impossible to externally control the imaging timing, and hence the imaging timing of each output image is unknown. Because this makes the relationship between an output image and the position of the focus lens become unknown, it is not possible to acquire a data set of a focusing evaluation value and the position of the focus lens.

Note that if it is possible to synchronize the internal time of the general-purpose digital camera with the external time, it is possible to calculate the position of the focus lens from an imaging time. For example, an imaging time is recorded on attribute information (for example, EXIF) of a captured image when the general-purpose digital camera captures the image. It is possible to acquire a data set of a focusing evaluation value and a focus lens position based on the imaging time recorded on a captured image and the record of a focus lens position at each time. However, as described above, it is not possible to synchronize the internal time of the general-purpose digital camera with the external time. This makes it impossible for a fundus camera to which a general-purpose digital camera is applied to use such a method.

For this reason, the fundus camera 100a according to the first embodiment superimposes at least one of the position information of the focus lens 4 and the time information of the fundus camera 100a (the external time of the digital camera 41) on illumination light applied to the eye E. This arrangement allows the live view image captured by the digital camera 41 to include the information of the position of the focus lens 4, at which the live view image has been captured, and the information of the external time of the digital camera 41.

The control unit 102a then extracts one of the position information of the focus lens 4 and the information of the external time of the digital camera 41 from an acquired live view image. This allows the control unit 102a to specify the position of the focus lens 4 or the external time of the digital camera 41 at the imaging time of the live view image.

An arrangement configured to superimpose the position information of the focus lens 4 on illumination light applied to the eye E allows the fundus camera 100a to generate a data set of a focusing evaluation value and the position of the focus lens 4. In this case, the fundus camera 100a calculates the focusing evaluation value of the live view image output from the digital camera 41 and extracts the position of the focus lens 4 from the live view image. The fundus camera 100a then generates a data set of the calculated focusing evaluation value and the extracted position of the focus lens 4.

Likewise, an arrangement configured to superimpose the time information of the fundus camera 100a on illumination light applied to the eye E allows the fundus camera 100a to generate a data set of a focusing evaluation value and the position of the focus lens 4. In this case, first of all, the fundus camera 100a records both the position information of the focus lens 4 and the time. The fundus camera 100a calculates the focusing evaluation value of the image output from the digital camera 41 and extracts time information from the image. The fundus camera 100a then specifies the position of the focus lens 4 at the time of capturing the image from the time extracted from the image and the position of the focus lens 4 recorded together with the time. The fundus camera 100a can therefore generate a data set of a focusing evaluation value and the position of the focus lens 4.

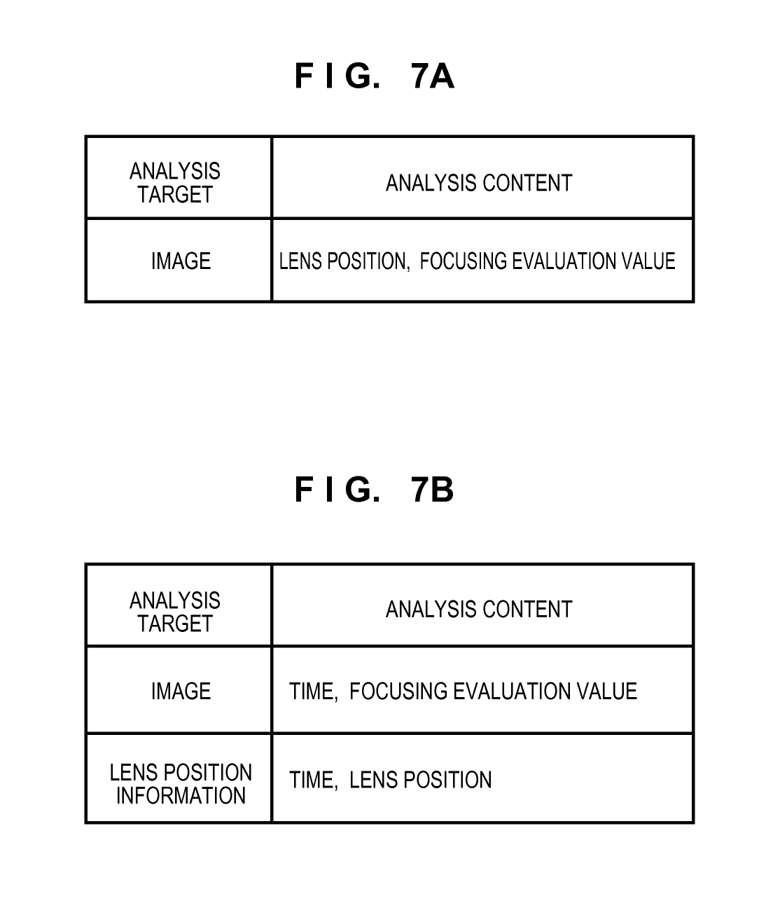

The above method can be summarized as shown in FIGS. 7A and 7B. FIG. 7A shows an arrangement configured to superimpose the position information of the focus lens 4 on light with which the eye E is irradiated. The fundus camera 100a extracts the position of the focus lens 4 at the time of capturing an image by analyzing the image output from the digital camera 41. The fundus camera 100a then calculates the focusing evaluation value of the image. In this manner, the fundus camera 100a can generate a data set of a focusing evaluation value and the position of the focus lens 4. FIG. 7B shows an arrangement configured to superimpose the time information of the fundus camera 100a on light with which the eye E is irradiated. In this arrangement, the fundus camera 100a has two analysis targets, namely the image output from the digital camera 41 and the recorded position information of the focus lens 4. The fundus camera 100a analyzes an image to extract the time at which the image was captured. The fundus camera 100a specifies the position of the focus lens 4 at the time of capturing an image based on the extracted time and the recorded position information of the focus lens 4. The fundus camera 100a can therefore generate a data set of a focusing evaluation value and the position of the focus lens 4.

Assume that the arrangement shown in FIG. 7B is applied to the fundus camera 100a according to the first embodiment.

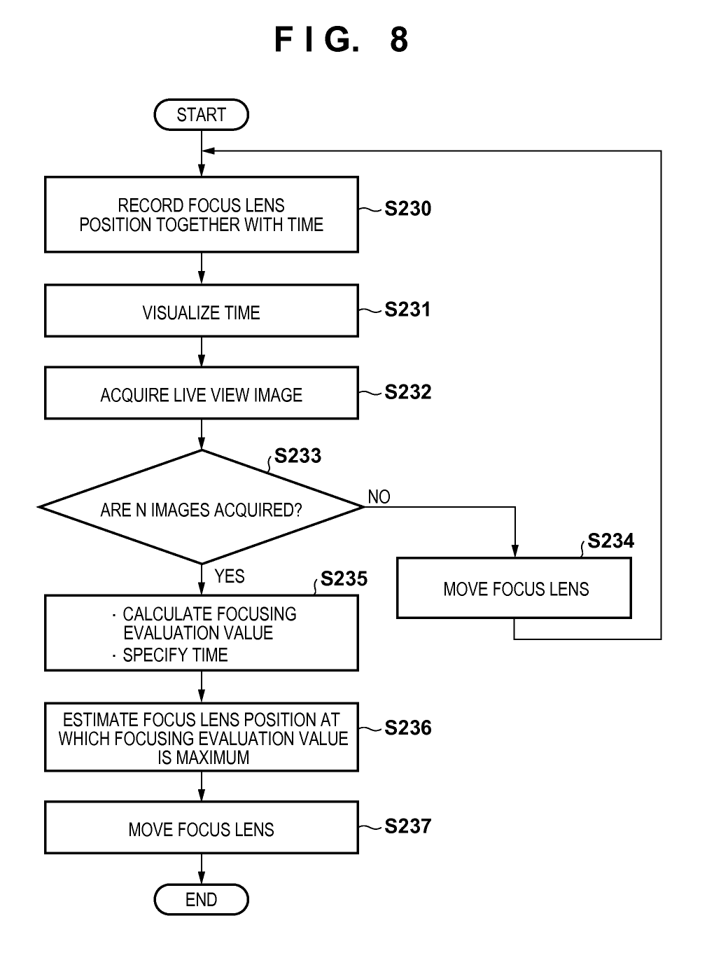

Focusing processing by the contrast focusing scheme of the fundus camera 100a according to the first embodiment will be described next with reference to FIG. 8. FIG. 8 is a flowchart showing a procedure for focusing processing by the contrast focusing scheme of the fundus camera 100a according to the first embodiment.

In step S230, the position recording unit 129 records the position of the focus lens 4 together with the time. The potentiometer 5 detects the position of the focus lens 4. The position recording unit 129 acquires the position of the focus lens 4 from the potentiometer 5 via the lens driving unit 103. The position recording unit 129 acquires the time from the time generator 105.

In step S231, the visualization unit 106a visualizes the time. Note that “to visualize the time” in the first embodiment is to superimpose time information on light with which the eye E is irradiated. In other words, it means to superimpose time information on the image captured by the general-purpose digital camera. For example, the modulation unit 127 of the visualization unit 106a generates a modulation signal in accordance with the time acquired from the time generator 105 and transmits the signal to the illumination unit 107. The illumination unit 107 of the visualization unit 106a modulates the amount of illumination light applied to the fundus portion Er of the eye E based on the modulation signal generated by the modulation unit 127. This allows the visualization unit 106a to superimpose time information on light with which the eye E is irradiated. A practical mode of modulation of the time will be described later.

In step S232, the image acquisition unit 109 acquires the live view image output from the digital camera 41. As described above, since time information is superimposed on illumination light applied to the eye E, the time information is also superimposed on the image captured by the digital camera 41.

In step S233, the image count determination unit 128 determines whether the total number of live view images acquired by the image acquisition unit 109 has reached a predetermined number N. If the total number of live view images acquired has not reached N (NO in step S233), the process advances to step S234.

In step S234, the image count determination unit 128 instructs the lens driving unit 103 to move the focus lens 4. The lens driving unit 103 instructs the position control unit 108 as a subsystem to move the focus lens 4. The moving position of the focus lens 4 is set in advance in accordance with the number of live view images acquired. The position control unit 108 moves the focus lens 4 to a predetermined position based on the number of live view images acquired by the image acquisition unit 109 and this setting.

Assume that in the first embodiment, predetermined positions to which the focus lens 4 is to move include four positions on the front side and four positions on the rear side with reference to the position of the focus lens 4 at which the lens is made to focus by the split focusing scheme. Therefore, the total number of predetermined positions to which the focus lens 4 moves is nine (N=9), including the reference position (the reference position, four positions on the front side, and four positions on the rear side). Note that these positions are set at equal intervals.

The camera repeats steps S230 to S233 until the image acquisition unit 109 acquires N live view images. If the total number becomes N (YES in step S233), the process shifts to step S235.

In step S235, the evaluation value calculation unit 111 calculates the focusing evaluation value of each of the N images acquired by the image acquisition unit 109. The following is an example of this operation. FIG. 9 is a view schematically showing an example of the live view image (fundus image I) output from the digital camera 41. As shown in FIG. 9, the macular region 302 and papillary portion 303 of the eye E are superimposed on the live view image (fundus image I). The evaluation value calculation unit 111 sets the area 304 for the calculation of a focusing evaluation value on the live view image. The evaluation value calculation unit 111 then calculates a focusing evaluation value as a value indicating the degree of focusing in the set area 304. For example, the evaluation value calculation unit 111 calculates a focusing evaluation value by adding a band-limited signal from the high-frequency component in the area 304. At the same time, the time specifying unit 112 specifies the time at which the image was captured, based on the relationship between the amount of illumination light emitted by the illumination unit 107 in step S231 and the average luminance of the live view image. A time specifying method will be described later.

In step S236, the lens driving unit 103 generates a data set of a position F of the focus lens 4 and a focusing evaluation value J (see FIG. 6). At this time, the lens driving unit 103 refers to the focusing evaluation value output from the evaluation value calculation unit 111, the time specified by the time specifying unit 112, and the information stored in the position recording unit 129. The lens driving unit 103 then estimates the position of the focus lens 4 at which the focusing evaluation value is highest, based on the generated data sets. More specifically, the lens driving unit 103 interpolates the focusing evaluation value of each image by an interpolation curve, and specifies the position of the focus lens 4 at which the interpolation curve exhibits a maximum value. The lens driving unit 103 then estimates the specified position as an infocus position.

In step S237, the lens driving unit 103 transmits the position of the focus lens 4, which is estimated in step S236, to the position control unit 108 as a subsystem. The position control unit 108 moves the focus lens 4 to the transmitted position.

Upon completing the above processing, the camera terminates the focusing processing (focusing operation) by the contrast focusing scheme. Note that upon terminating the focusing processing by the contrast focusing scheme, the control unit 102a notifies the examiner of the completion of focusing. As a notifying method, for example, a method using a buzzer sound is available.

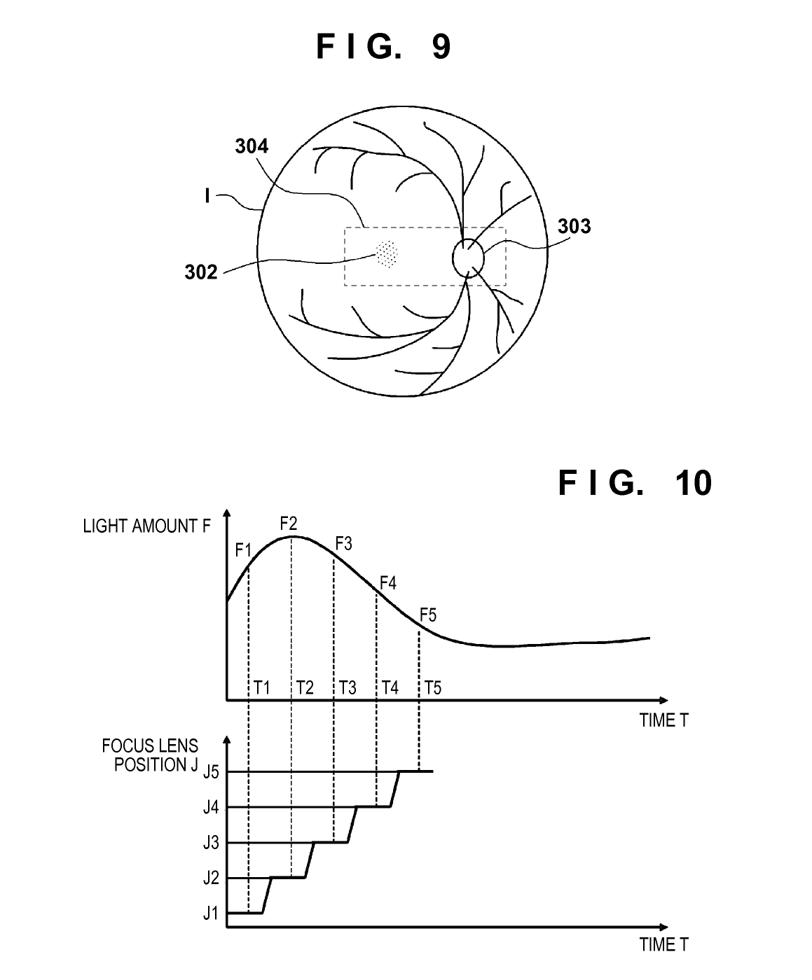

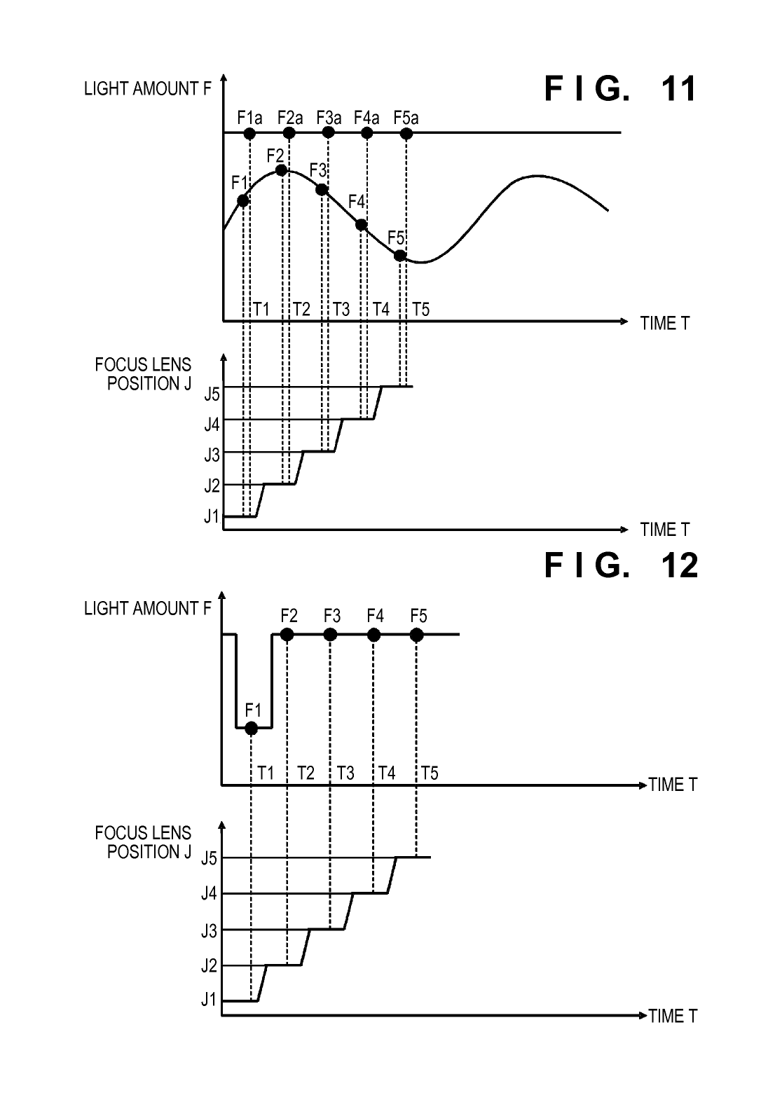

A practical mode of superimposing time information on illumination light will be described below with reference to FIG. 10. FIG. 10 is a graph (upper portion) showing the relationship between the time and the amount of light emitted by the illumination unit 107 and a graph (lower portion) showing the relationship between the time and the position of the focus lens 4. The fundus camera 100a according to the first embodiment records the amount of illumination light applied to the eye E, the position of the focus lens 4, and the time generated by the time generator 105. As shown in FIG. 10, with the lapse of time, the lens driving unit 103 moves the focus lens 4, and at the same time, the illumination unit 107 modulates the amount of light applied in accordance with the modulation signal generated by the modulation unit 127. In the case shown in FIG. 10, the focus lens 4 is located at the position of F1 at time T1, and the amount of light is represented by F1. The focus lens 4 is located at the position of F2 at time T2, and the amount of light is represented by F2.

The time specifying unit 112 extracts time information from the captured live view image (fundus image I) captured by using the illumination light modulated in accordance with time. With this operation, the time specifying unit 112 specifies the imaging time of the live view image. More specifically, the time specifying unit 112 operates as follows. The live view images captured by using illumination light modulated in accordance with time vary in average luminance in accordance with the imaging time. Although the amounts of light are almost proportional to the average luminances of live view images, they do not have a relationship of equality. The magnitude of a proportional multiplier varies depending on the reflectance of light at the eye E, and hence cannot be uniquely determined. For this reason, with one image alone, the time specifying unit 112 cannot extract time information included in the live view image (specify an imaging time). The time specifying unit 112 therefore derives the relationship between a light amount F modulated in accordance with time and the time by arranging a series of N live view images in the order of imaging. For example, as shown in FIG. 10, the time specifying unit 112 determines the relationship between the average luminances of live view images and the light amounts F of illumination light by arranging a series of N live view images in the order of imaging. If the average luminances of a series of N live view images have a proportional relationship with the amounts of light modulated shown on the upper portion of FIG. 10, the time specifying unit 112 specifies the imaging times of the N live view images as times T1, T2, T3, T4, and T5. As shown on the lower portion of FIG. 10, the focus lens 4 repeatedly moves and stops. It is not necessary to accurately calculate time T because there are pauses between movements. That is, if it is possible to specify that a given live view image “has been captured at a time near time T1”, it is possible to specify that the focus lens 4 is located at the position J1 at the time of capturing the given live view image.

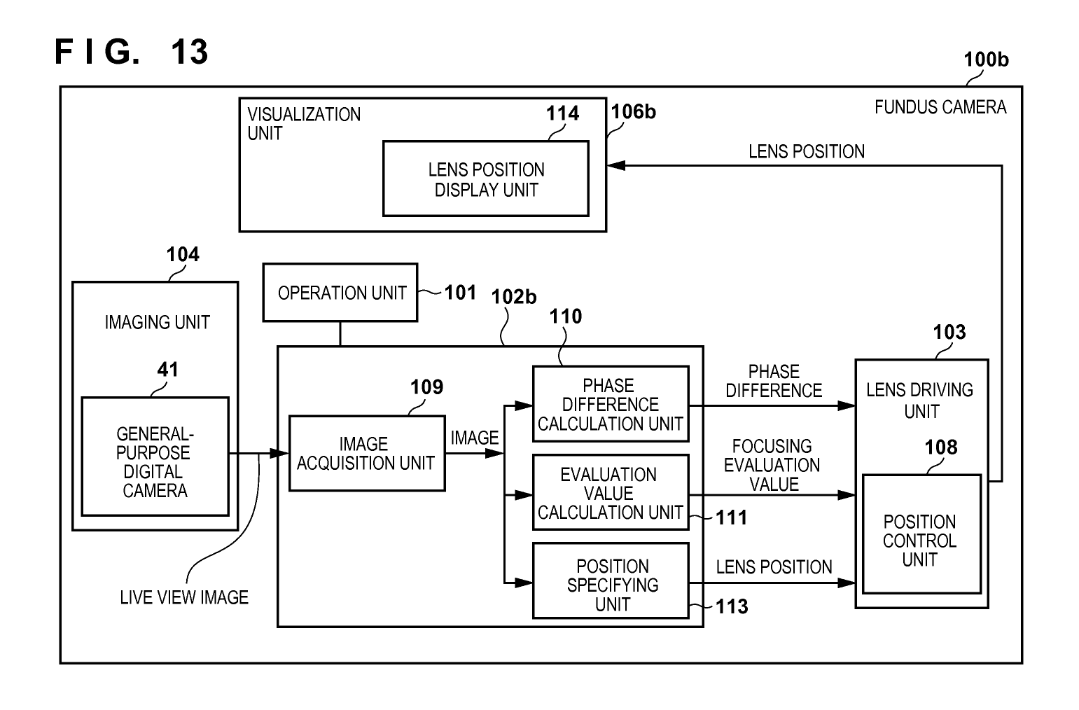

A first modification of the modulation mode of the amount of illumination light will be described below with reference to FIG. 11. FIG. 11 is a graph (upper portion) showing the relationship between the time and the amount of light emitted by the object illumination unit 107 and a graph (lower portion) showing the relationship between the time and the position of the focus lens 4 in the first modification.

For the calculation of focusing evaluation values by the evaluation value calculation unit 111, the amount of illumination light applied to the fundus portion Er of the eye E is preferably constant. For this reason, as shown on the upper portion of FIG. 11, the visualization unit 106a (modulation unit 127 and illumination unit 107) changes the light amount F to F1, F1a, F2, F2a, F3, F3a, F4, F4a, F5, and F5a in the order named with the lapse of time. In this case, the light amounts F1a, F2a, F3a, F4a, and F5a are the same value. In contrast, the light amounts F1, F2, F3, F4, and F5 differ with time. The evaluation value calculation unit 111 then calculates focusing evaluation values based on live view images captured with the light amounts F1a, F2a, F3a, F4a, and F5a of illumination light (see step S235 in FIG. 8). According to this arrangement, it is possible to calculate focusing evaluation values based on images with the constant amount F of illumination light.

A second modification of the modulation mode of amounts of illumination light will be further described below with reference to FIG. 12. FIG. 12 is a graph (upper portion) showing the relationship between the time and the amount of light emitted by the object illumination unit 107 and a graph (lower portion) showing the relationship between the time and the position of the focus lens 4 in the second modification.

As shown in FIG. 12, the illumination unit 107 makes only the first-time (first) light amount F1 different from the other light amounts F2 to F5 of illumination light corresponding to the positions J1 to J5 of the focus lens 4. This arrangement superimposes time information on the live view image captured with the first-time light amount F1. The time specifying unit 112 can therefore specify the imaging time of one live view image captured with the light amount F1 by comparing the average luminances of a series of N live view images upon arranging them in the order of imaging. The time specifying unit 112 can specify the imaging times of the remaining live view images based on the specified imaging time of one live view image and imaging intervals. FIG. 12 shows an arrangement in which “light amount F1<light amounts F2 to F5”. However, an arrangement in which “light amount F1>light amounts F2 to F5” may be used. In this arrangement, since time information is superimposed on only one live view image captured with the first-time light amount F1, the time specifying accuracy may deteriorate as time elapses as compared with the first modification. Therefore, this arrangement is preferably configured to repeat the processing of superimposing time information in a predetermined cycle.

The first embodiment can obtain the following effect.

As described above, some digital cameras are not equipped with a terminal for externally inputting control signals. A fundus camera to which such a general-purpose digital camera is applied cannot control the imaging timing of each live view image by the general-purpose digital camera, and hence the imaging time of each live view image is unknown. In addition, the fundus camera with this arrangement cannot synchronize the internal time of the general-purpose digital camera with other times. This makes the position of the focus lens unknown at the time of capturing a live view image, and hence makes it impossible to execute focusing processing by the contrast focusing scheme.

According to the first embodiment, however, it is possible to superimpose time information on the live view image acquired by the image acquisition unit 109 by superimposing the time information on illumination light. This allows the lens driving unit 103 to specify the imaging time (the time generated by the time generator 105 in this case) of the live view image acquired by the image acquisition unit 109. The lens driving unit 103 then can specify the position of the focus lens 4 at the time of capturing each live view image by referring to the position of the focus lens 4 recorded by the position recording unit 129 at each time. The lens driving unit 103 can therefore acquire a data set of the position of the focus lens 4 and the focusing evaluation value of the captured live view image. As a result, the control unit 102a and the lens driving unit 103 can execute focusing processing by the contrast focusing scheme.

As described above, according to the first embodiment, even if it is not possible to control the imaging timing of a live view image by the general-purpose digital camera 41, it is possible to execute focusing processing by the contrast focusing scheme. In addition, according to the first embodiment, even if it is not possible to synchronize the internal time of the digital camera 41 with the external time, it is possible to execute focusing processing by the contrast focusing scheme. The first embodiment can therefore execute focusing processing by the contrast focusing scheme by using an inexpensive general-purpose digital camera instead of an expensive industrial digital camera. In particular, this embodiment can use, as a general-purpose digital camera, a digital camera having no input terminal for control or a digital camera which cannot establish synchronization between the internal time and the external time. This can therefore achieve a reduction in the cost of a fundus camera and capture the high-resolution, high-quality fundus image I by an autofocus scheme.

Note that the digital camera 41 to be applied to the first embodiment may be a general-purpose digital camera having no optical viewfinder. For example, a so-called mirrorless type digital camera may be used. This is because, since the non-mydriatic fundus camera is configured to observe the fundus portion Er illuminated with infrared light, no optical viewfinder is useful. For example, when trying to observe a fundus image through the optical viewfinder, the examiner (operator) can only see a black image since it is illuminated with infrared light. An arrangement using a general-purpose digital camera having no optical viewfinder can achieve reductions in the size and cost of a fundus camera as compared with an arrangement using a general-purpose digital camera having an optical viewfinder. Note that it is possible to use a digital camera of a type called a compact digital camera as a general-purpose digital camera having no optical viewfinder.

The first embodiment has exemplified the arrangement in which the evaluation value calculation unit 111 calculates focusing evaluation values based on live view images. However, the embodiment may use an arrangement configured to calculate focusing evaluation values based on general still images. The imaging intervals of live view images are shorter than those of general still images. For this reason, using the arrangement configured to calculate focusing evaluation values based on live view images can shorten the time required for autofocus processing. However, general still images may be used for the calculation of focusing evaluation values. Even capturing of general still images has the same problem as that described above. The first embodiment can therefore solve the above problem even by using the arrangement configured to calculate focusing evaluation values by using general still images.

### Second Embodiment

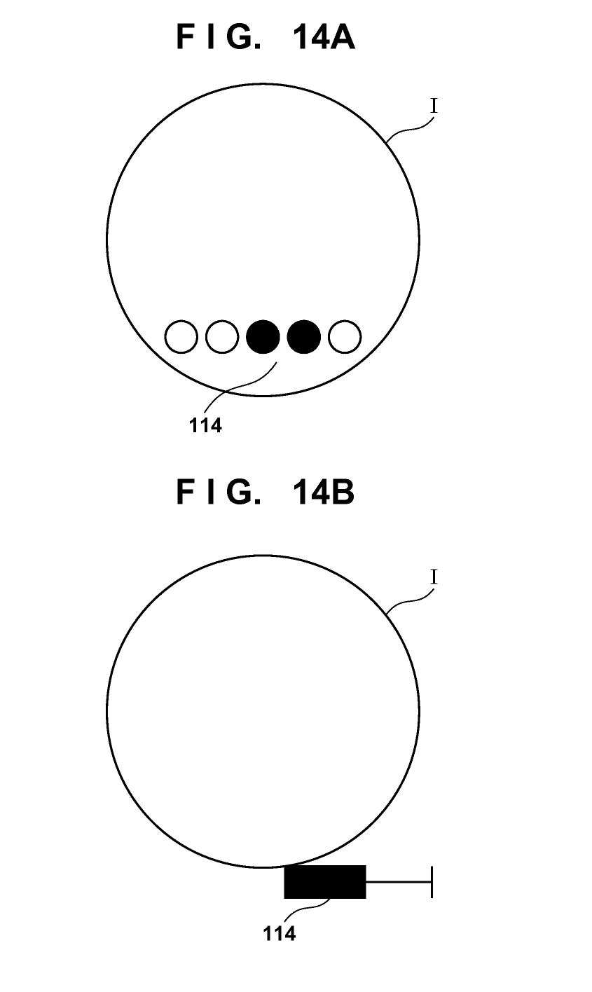

The second embodiment of the present invention will be described next with reference to FIG. 13. FIG. 13 is a block diagram schematically showing the arrangement of a fundus camera 100b according to the second embodiment. Note that the same reference numerals denote components common to the first embodiment, and a description of them will be omitted.

The fundus camera 100b according to the second embodiment is a mydriatic fundus camera equipped with an autofocus function which automatically drives a focus lens 4. The first embodiment exemplifies the arrangement configured to superimpose time information on illumination light (see FIG. 7B). In contrast to this, the second embodiment exemplifies the arrangement configured to superimpose the position information of the focus lens 4 on illumination light (see FIG. 7A).

As shown in FIG. 13, the fundus camera 100b according to the second embodiment includes a position specifying unit 113 for specifying the position of the lens as a subsystem of a control unit 102b, and a lens position display unit 114 as a subsystem of a visualization unit 106b.

The lens position display unit 114 displays the current position of the focus lens 4 in the visual field of a digital camera 41. That is, the lens position display unit 114 (the current position of the focus lens 4 displayed by the lens position display unit 114) is superimposed on the image captured by the digital camera 41. FIGS. 14A and 14B are views each schematically showing an example of the display mode of the current position of the focus lens 4 by the lens position display unit 114. For example, as shown in FIG. 14A, the lens position display unit 114 includes a plurality of light-emitting elements (for example, LEDs) arranged side by side at positions in the visual field (image) of the digital camera 41 at which they do not interfere with the observation of a fundus portion Er of an eye E to be examined. The lens position display unit 114 displays the current position of the focus lens 4 in binary form with each ON indication representing “1” and each OFF indication representing “0”. As shown in FIG. 14B, the lens position display unit 114 includes a display device which displays a variable-length bar. The lens position display unit 114 changes the length of the bar in accordance with the current position of the focus lens 4. In this manner, the lens position display unit 114 displays the current position of the focus lens 4 with the length of the bar.

The position specifying unit 113 extracts lens position information to be superimposed (displayed) on a live view image and specifies the position of the focus lens 4 at the time of capturing the live view image. If, for example, the lens position display unit 114 has the arrangement shown in FIG. 14A, the position specifying unit 113 determines the binary number displayed by the lens position display unit 114 by analyzing the binarized image obtained by binarizing a live view image with predetermined luminances. The position specifying unit 113 then specifies the position of the focus lens 4 based on the binary number extracted from the live view image. If the lens position display unit 114 has the arrangement shown in FIG. 14B, the position specifying unit 113 acquires the position of the focus lens 4 by measuring the length of the bar. Note that the relationship between the positions of the focus lens 4 and binary numbers is defined in advance. Likewise, the relationship between the positions of the focus lens 4 and bar lengths is also defined in advance.

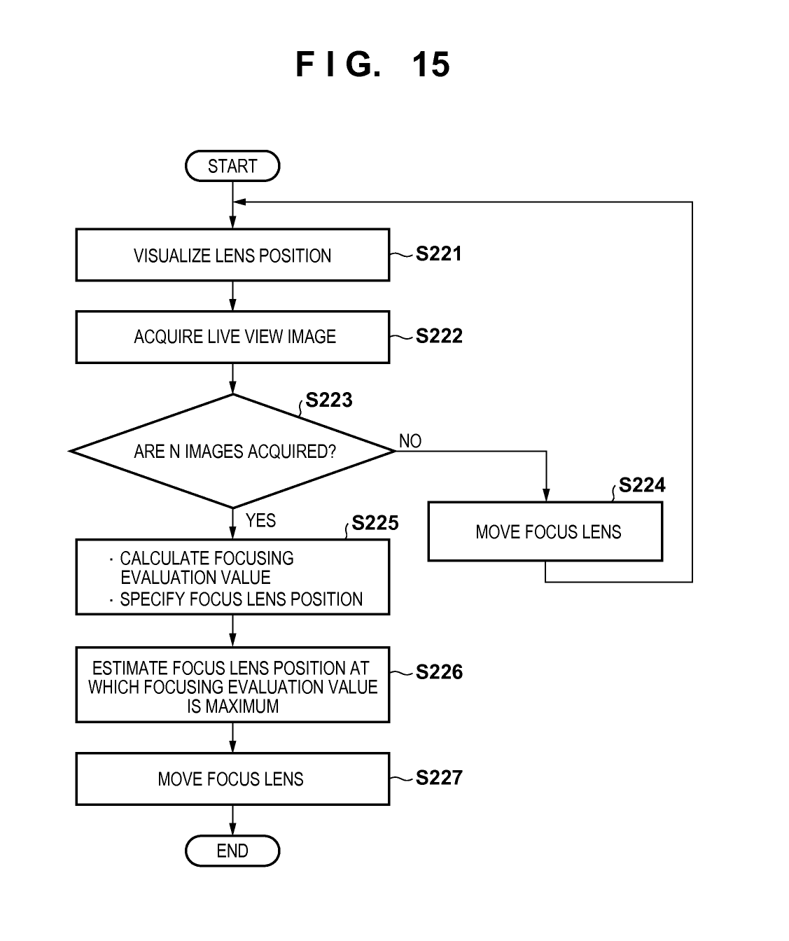

Focusing processing (focusing operation) by the contrast focusing scheme of the fundus camera 100b according to the second embodiment will be described with reference to FIG. 15. FIG. 15 is a flowchart showing the content of focusing processing by the contrast focusing scheme of the fundus camera 100b according to the second embodiment.

In step S221, the visualization unit 106b visualizes the position of the focus lens 4. More specifically, the lens position display unit 114 of the visualization unit 106b displays information indicating the current position of the focus lens 4 so as to superimpose the information on the live view image (fundus image I) captured by the digital camera 41.

Steps S222 to S224 are the same as steps S222 to S224 in the first embodiment.

In step S225, an evaluation value calculation unit 111 calculates the focusing evaluation values of N live view images (fundus images I) acquired by an image acquisition unit 109 one by one. As a method of calculating focusing evaluation values, the same method as that in the first embodiment can be used. At the same time, the position specifying unit 113 analyzes the display on the lens position display unit 114 which is superimposed on a live view image (fundus image I), and specifies the position of the focus lens 4 at the time of capturing the live view image (fundus image I).

Steps S226 and S227 are the same as steps S236 and S237 in the first embodiment.

The second embodiment can obtain the same effects as those of the first embodiment. Although the first embodiment is configured to illuminate the fundus portion Er of the eye E with near infrared light, the second embodiment may be configured to illuminate the fundus portion Er of the eye E with near infrared light or visible light. In an arrangement configured to illuminate the fundus portion Er of the eye E with visible light, the CMOS area sensor 43 of the digital camera 41 may use an infrared cut filter for cutting infrared light.

### Third Embodiment

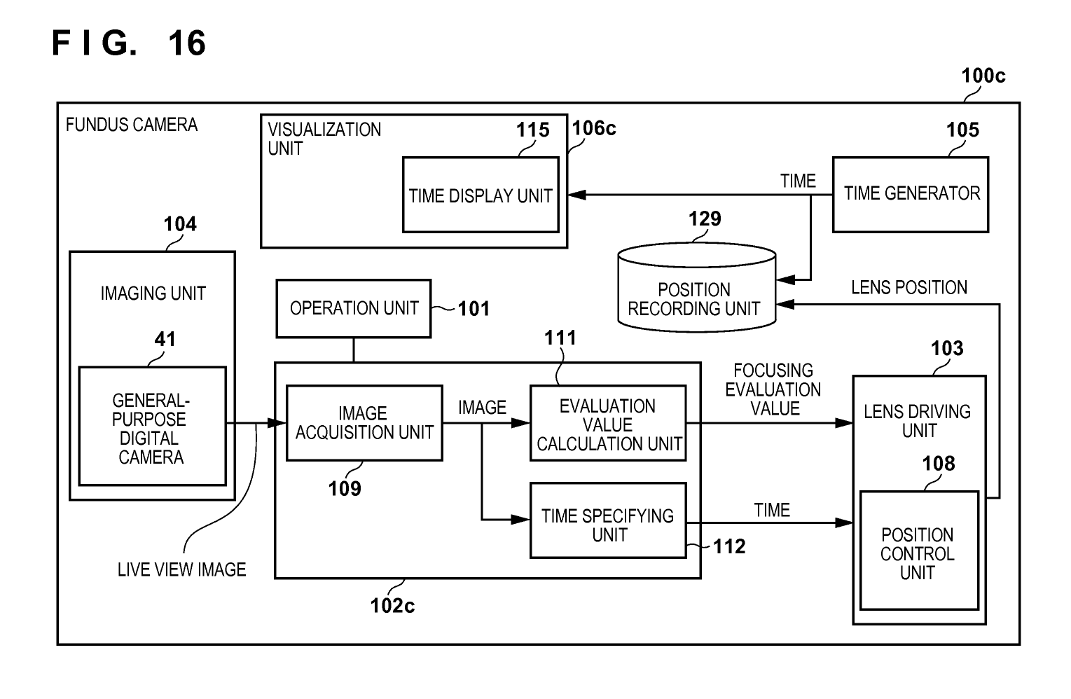

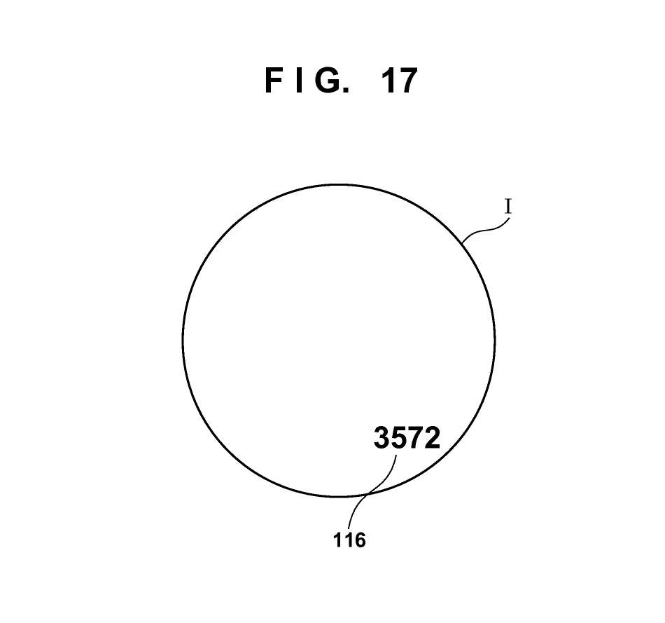

The third embodiment of the present invention will be described next with reference to FIG. 16. FIG. 16 is a block diagram schematically showing the arrangement of a fundus camera 100c according to the third embodiment of the present invention. Note that the same reference numerals denote components common to the first embodiment, and a description of them will be omitted. The fundus camera 100c according to the third embodiment is a non-mydriatic fundus camera equipped with an autofocus function which automatically drives a focus lens 4.

The third embodiment is an arrangement configured to superimpose time information on illumination light. As shown in FIG. 16, a visualization unit 106c includes a time display unit 115 as a subsystem. The time display unit 115 displays the time acquired from a time generator 105 in the visual field of a digital camera 41 (so as to be superimposed on the live view image captured by the digital camera 41) in real time. FIG. 17 is a view schematically showing an example of the image captured by the digital camera 41 of the fundus camera 100c according to the third embodiment. As shown in FIG. 17, the live view image captured by the digital camera 41 is provided with a time display area 116. For example, an LED display device is applied as the time display unit 115 to display time information in number in the time display area 116. This arrangement allows the time display unit 115 to superimpose (add) time information (number) on a live view image (fundus image I) captured by the digital camera 41.

A time specifying unit 112 specifies the time indicated by the time display area 116 by executing character recognition processing for the live view image (fundus image I) (the image in which the time indication is superimposed on the time display area 116) acquired by an image acquisition unit 109.

As focusing processing by the contrast focusing scheme in the third embodiment, it is possible to apply the same processing as that in the first embodiment except for step S235 (see FIG. 8). In contrast to the arrangement in the first embodiment in which times are specified based on the average luminances of images, the third embodiment is configured to specify times by character recognition as described above.

The third embodiment can obtain the same effects as those of the first embodiment.

The hardware arrangement of a fundus camera according to each embodiment will be lastly described. As shown in FIG. 2, the fundus camera 100a according to the first embodiment includes the operation unit 101, the control unit 102a and lens driving unit 103 which serve as an autofocus control unit, the time generator 105, the position recording unit 129, and the visualization unit 106a. As shown in FIG. 13, the fundus camera 100b according to the second embodiment includes the operation unit 101, the control unit 102b and lens driving unit 103 which serve as an autofocus control unit, the time generator 105, and the visualization unit 106b. As shown in FIG. 16, the fundus camera 100c according to the third embodiment includes the operation unit 101, the control unit 102c and lens driving unit 103 which serve as an autofocus control unit, the time generator 105, the position recording unit 129, and the visualization unit 106c. These hardware arrangements are computers each including a CPU which executes predetermined computation, a recording device which can record programs (software) and various data and settings, and a user interface operated by the operator. These arrangements may include a common CPU, recording device, and user interface or each may include a CPU, recording device, and user interface. The recording device stores computer programs (computer software) for executing the respective processes (operations) described above. The recording device also stores information (settings and the like) necessary for the execution of the respective processes described above. The CPU executes the respective processes (operations) described above by reading out and executing programs from the recording device.

As described above, the above embodiment is suitable for a fundus camera equipped with an autofocus function which automatically drives a focus lens. According to the above embodiment, it is possible to implement a fundus camera equipped with an autofocus function by using only a general-purpose digital camera without using any industrial digital camera. This makes it possible to provide high-resolution, high-quality fundus images to the user as compared with the case of using an industrial digital camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-130197, filed Jun. 7, 2012, which is hereby incorporated by reference herein in its entirety.

What is claimed is:

1. A fundus camera having an autofocus function which automatically drives a focus lens, the camera comprising:
a general-purpose digital camera having a live view function;
an acquisition unit configured to acquire a live view image captured by said general-purpose digital camera; and
a control unit configured to drive the focus lens based on the live view image.

2. The camera according to claim 1, wherein said control unit performs focusing processing by a split focusing scheme.

3. The camera according to claim 2, wherein said control unit performs focusing processing by a contrast focusing scheme after executing focusing processing by the split focusing scheme.

4. The camera according to claim 3, wherein said control unit further comprises a calculation unit configured to calculate a focusing evaluation value of each live view image, and a time specifying unit configured to specify an imaging time of each live view image, and
performs focusing processing by the contrast focusing scheme based on a position of the focus lens at the imaging time specified by said time specifying unit and a focusing evaluation value calculated by said calculation unit.

5. The camera according to claim 4, further comprising:
a time generation unit configured to generate a time;
a visualization unit configured to visualize and superimpose information of the time generated by said time generation unit on the live view image; and
a recording unit configured to record the position of the focus lens together with the time generated by said time generation unit,
wherein said control unit specifies the position of the focus lens at an imaging time of the live view image based on the information of the time superimposed on the live view image and the position of the focus lens recorded on said recording unit.

6. The camera according to claim 3, wherein said control unit further comprises a calculation unit configured to calculate a focusing evaluation value of each live view image, and a position specifying unit configured to specify the position of the focus lens at the imaging time of each live view image, and
performs focusing processing by the contrast focusing scheme based on the position of the focus lens at the imaging time specified by said position specifying unit and the focusing evaluation value calculated by said calculation unit.

7. The camera according to claim 6, further comprising a visualization unit configured to visualize and superimpose the position information of the focus lens on the live view image,
wherein said control unit specifies the position of the focus lens at the imaging time of the live view image based on the position information of the focus lens superimposed on the live view image.

8. The camera according to claim 7, wherein said visualization unit displays the position of the focus lens in binary form.

9. The camera according to claim 1, wherein said digital camera includes no optical viewfinder and is configured to image an eye to be examined as an object illuminated with near infrared light.

10. The camera according to claim 9, wherein said digital camera has sensitivity in an infrared band.

11. The camera according to claim 1, wherein the focus lens comprises a focus lens of a fundus camera configured to image a fundus of an eye to be examined.

12. The camera according claim 1, further comprising a switching unit configured to switch between a first mode of making said digital camera obtain an infrared image of an eye portion by irradiating an eye to be examined with infrared light and a second mode of making said digital camera obtain a visible image of an eye portion by irradiating an eye to be examined with visible light.

13. The camera according to claim 1, wherein said digital camera comprises an image sensor having sensitivity to infrared light and visible light,
a display unit, and
a display control unit configured to execute the live view function by causing said display unit to sequentially display images obtained by said image sensor in accordance with reception of light.

14. A method of capturing a fundus image, the method comprising:
a step of acquiring a live view image captured by a general-purpose digital camera having a live view function; and
a step of performing focusing processing by driving a focus lens using the live view image.

15. The method according to claim 14, wherein the step of performing the focusing processing further comprises a step of calculating a focusing evaluation value of each live view image, and a step of specifying an imaging time of each live view image,
wherein focusing processing is performed by the contrast focusing scheme using a position of the focus lens at the specified imaging time and a calculated focusing evaluation value.

16. The method according to claim 14, wherein the step of performing the focusing processing further comprises a step of calculating a focusing evaluation value of said each live view image, and a step of specifying the position of the focus lens at the imaging time of said each live view image,
wherein focusing processing is performed by the contrast focusing scheme using the position of the focus lens at the specified imaging time and the calculated focusing evaluation value.

17. A fundus camera having an autofocus function, the camera comprising:
a first optical system configured to irradiate an eye to be examined with illumination light;
a second optical system configured to guide light from the eye illuminated with the illumination light, said second optical system including a focus lens;
a detachable general-purpose digital camera configured to receive light guided by said second optical system, said digital camera including an image sensor having sensitivity to infrared light and visible light;
a display unit;
a display control circuit configured to sequentially display captured images obtained in accordance with reception of light by said image sensor to said display unit; and
a control unit configured to drive the focus lens based on the captured image.
